(19) United States
(12) Patent Application Publication
(10) Pub. No.: US 2012/0029104 A1
(43) Pub. Date: Feb. 2, 2012

(54) COMPOSITION COMPRISING STABLE POLYOL MIXTURES

(75) Inventors: René Nagelsdiek, Hamminkeln (DE); Bernd Göbelt, Wesel (DE); Dorothée Greefrath, Mulheim an der Ruhr (DE); Christian Biecker, Wesel (DE)

(73) Assignee: BYK-CHEMIE GMBH, Wesel (DE)

(21) Appl. No.: 13/223,476

(22) Filed: Sep. 1, 2011

Related U.S. Application Data
(63) Continuation of application No. PCT/EP2010/001859, filed on Mar. 25, 2010.

(30) Foreign Application Priority Data
Mar. 25, 2009 (DE) 10 2009 014 226.6
May 27, 2009 (DE) 10 2009 022 854.3

(51) Int. Cl. C08L 75/06; C08J 9/228; C08L 33/14

(52) U.S. Cl. 521/157; 525/421; 524/607; 521/183

(57) ABSTRACT

Single-phase fluid compositions, comprising at least two isocyanate-reactive polyol components which are inherently incompatible with each other and as a mediator additive at least one copolymer compatibilizer additive effectuating compatibility between the originally incompatible polyol components, said copolymer comprising structural units having at least one nitrogen group which can be protonized.

The present invention relates to monophasic, liquid compositions comprising at least two inherently incompatible, isocyanate-reactive polyol components and, as compatibilizer additive, at least a copolymer which effectuates the compatibility between the inherently incompatible polyol components and which is constructed of certain, hereinbelow recited structural units of which some have at least one protonatable nitrogenous group and which are optionally at least partly salted with at least one organic compound having at least an acidic group and/or optionally at least partly quaternized with an organic alkylating compound, and also to their use for production of polyurethanes.

Polyurethanes are members of that class of materials of construction which are widely used in a wide variety of forms. They can be used in the form of rigid or flexible foams or in compact form as coatings, adhesives, sealants or elastomers (CASE applications). To ensure that the polyurethane used has the best possible performance profile required for the particular application, careful selection of starting components is required.

Polyurethanes are produced by reaction of polyols with polyisocyanates. While the selection of polyisocyanates available on a large industrial scale is limited, there are a multiplicity of polyols which can be used. These range from polyether polyols to polyester polyols to low molecular weight polyols used as chain extenders or chain crosslinkers for example.

Typically, a polyurethane is produced by reacting not just one specific polyol with polyisocyanates, but a mixture of various polyols, which can be of low or comparatively high molecular weight. In many cases, a mixture of polyols used is not stable, but tends to phase separate over time at least. This separation is due to the incompatibility of the polyols used. The incompatibility can have various causes, for example different molecular weights, different monomeric compositions, different polarities and/or different constructions (e.g., random or block construction) of the polyols. Irrespective of its cause, the incompatibility leads to diverse problems with the handling and processing of such polyol mixtures. For a start, storage or transportation of such a polyol mixture even for short periods is in many cases not possible because of the separation tendency between the polyols. Therefore, before such polyol mixtures can be processed, renewed commixing has to be provided to ensure homogeneous dispersion of polyol components. This requires the polyurethane producer to invest in mixing equipment which, moreover, leads to increased energy consumption. In addition, there is a risk with inadequate commixing of polyol components that the polyurethane produced therefrom will not have the desired performance profile. Therefore, there has been no shortage of attempts to at least ameliorate this separation problem of polyol components.

One possible way to counteract the separation of incompatible polyol components considered in the prior art, for example U.S. Pat. No. 4,312,973, is to modify the structure of incompatible polyol components such that they remain mixed with each other to a sufficiently stable extent. Since, however, modifying the polyol components ultimately also risks modifying the performance profile of polyurethanes produced therefrom, this solution to the separation problem is in many cases not applicable. In addition, polyurethane producers are mostly not producers of polyol components used, and so are forced to achieve the desired polyurethane performance profile using polyol components available in the marketplace.

A further attempt to solve the separation problem of incompatible polyol components in the prior art is to use a component that confers compatibility between the incompatible polyol components to at least slow the separation tendency between the incompatible polyol components.

U.S. Pat. No. 4,125,505 writes that polyalkylene oxides having a certain construction as one of the polyol components can be improved in their compatibility with an inherently incompatible chain extender, such as a low molecular weight polyol, by means of particulate addition polymers formed from unsaturated monomers such as, for example, styrene-acrylonitrile copolymers. The disadvantage here to the polyurethane producer is that the dispersed particles of polymer, if not used directly, can sediment or have an unintended influence on the mechanical properties of the polyurethane produced therefrom.

U.S. Pat. No. 5,344,584 proposes admixing a mixture of two isocyanate-reactive compounds that are normally not miscible with each other with a surface-active compound which, as carboxylic ester or carboxamide, has acidic groups. The polycarboxylic ester preferably derives from a hydroxycarboxylic acid or from a ring-opened lactone. Adding the surface-active compound to the inherently incompatible polyol components does improve compatibility, but not always to the desired extent. In addition, these polycarboxylic esters are also not universally applicable because of their possible reactivity.

Limitations are also likely with the use, disclosed in U.S. Pat. No. 4,673,696, of unsaturated esterols as compatibilizers between short-chain and long-chain, isocyanate-reactive polyol components which are inherently incompatible with each other. This is particularly because these mixtures can only be used to produce certain polyurethanes where the use of ethylenically unsaturated esterols is unlikely to result in unwanted by-reactions. These compatibilizers are again not always able to provide a compatibility improvement to the desired extent.

It is an object of the present invention to remedy the disadvantages of the prior art and to suppress the separation tendency of inherently incompatible, isocyanate-reactive polyol components differing in construction, polarity and/or molecular weight as far as possible until their further reactive conversion into polyurethanes.

An inherently incompatible mixture for the purposes of the present invention is a mixture of at least two inherently incompatible polyols which, on storage at a temperature of 40° C., represents with visible (to the naked eye) two-phase formation within one week of it being mixed with customary mixing appliances to the point of monophasicness.

This object is achieved by providing the liquid composition of the present invention, which has a storage-stable monophasicness and comprises
(1) an isocyanate-reactive polyol component,
(2) at least one further isocyanate-reactive polyol component, this polyol component being inherently incompatible with the polyol component (1), and
(3) as compatibilizer additive at least one copolymer effectuating the monophasicness between the polyol components (1) and (2),
wherein the copolymer may comprise the following structural units I to VI and is constructed of at least one of the structural units I to III and of at least one of the structural units IV to VI:

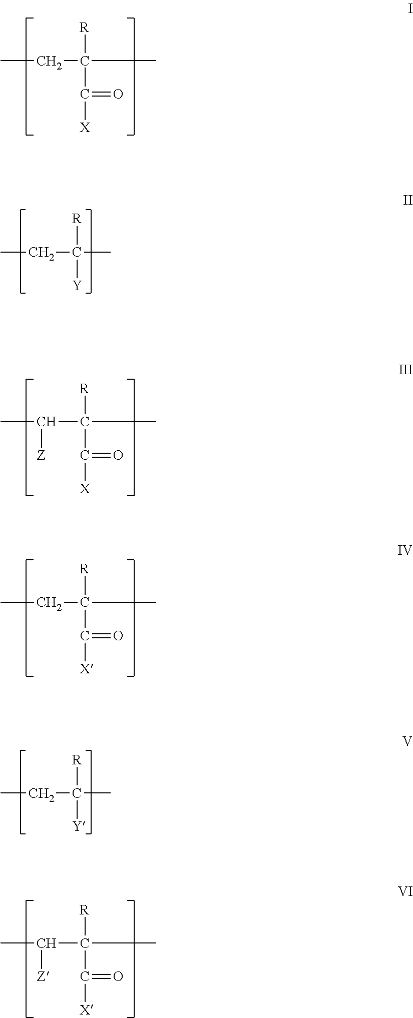

where
R represents hydrogen or an alkyl radical,
X represents an —OR₁ group or an

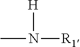

group, where
R₁ represents hydrogen, an alkyl radical, an alkenyl radical, an alkylene radical having a functional group, a cycloalkyl radical, an aromatic radical, wherein each of these radicals may optionally also be substituted, a polyether radical or polyester radical or a polyether/polyester radical;
Y represents an optionally substituted, aromatic non-basic radical of 4-12 carbon atoms which optionally has at least one heteroatom as ring member, a
   lactam radical of 4-8 carbon atoms, a polyether or polyester radical attached by an —O— or

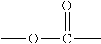

bridge, or an

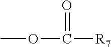

group, where
R₇ represents an optionally substituted alkyl radical or an optionally substituted cycloalkyl radical;
Z represents a —COOR₁ group, where R₁ is as defined above, or
Z combines with the

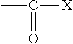

group where X is an —OR₁ group and R₁ represents hydrogen to form a cyclic anhydride group or where X is an

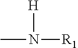

group to form a cyclic imide group whose nitrogen is substituted with an R₁ radical as defined above,
X′ represents an

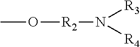

group or a corresponding, quaternized

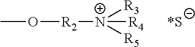

group, represents an

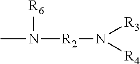

group or a corresponding, quaternized

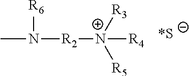

group, where R₂ represents an aliphatic radical, preferably an alkylene radical, or an aromatic radical, preferably arylene radical,
R₃, R₄ and R₅ are the same or different and each represent an alkyl radical, an aryl radical or arylalkylene radical, and the radicals R₃-R₅, which may optionally be substituted with a functional group, preferably a hydroxyl group,
R₆, the same or different, has the meaning of one of the radicals R₃-R₅ or represents hydrogen,
S⊖ represents the remaining, anionic radical of one of the hereinbelow recited alkylating compounds (4′), preferably a halide anion and more preferably chloride, bromide or iodide, or represents a sulfate anion or carboxylate anion, or
X′ represents a

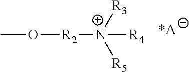

group or a

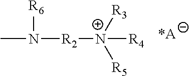

group, where
R₂ is as defined above,
R₃, R₄, R₅ and R₆ are each as defined above, but at least one of R₃-R₅ represents hydrogen, and
A⊖ represents the remaining, anionic radical of one of the hereinbelow recited salting compounds (4), or
X′ as an

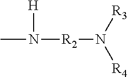

group combines with Z′ as a —COOR₁ group to form a cyclic imide group whose nitrogen is substituted with the

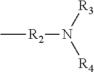

group or with a corresponding,

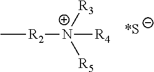

quaternized group or with a corresponding, salted

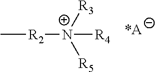

group,
where the radicals R₃, R₄, R₅, A⊖ and S⊖ are each as defined above,
Y′ represents an N-containing, heterocyclic, basic free radical, preferably an aromatic free radical containing at least one nitrogen atom and optionally further heteroatoms as ring members, or represents a saturated or unsaturated cycloaliphatic free radical containing at least one nitrogen atom and optionally further heteroatoms as ring members,
Z′, which is identical to or different from X′, represents a grouping having the meaning of X′ or represents a —COOR₁ group, where R₁ is as defined above,
   where the structural units IV to VI are optionally at least partly present as salted with at least one preferably oligomeric organic compound (4) having at least one acidic group and/or optionally at least partly present as quaternized with an organic alkylating compound (4′).

A mixture having a storage-stable monophasicness for the purposes of the present invention is an inherently incompatible mixture of two inherently incompatible polyols which, after addition of a compatibilizer additive (3) and mixing with customary mixing appliances to the point of monophasicness, have no visible (to the naked eye) two-phase formation within one week in the course of a subsequent storage at a temperature of 40° C.

The compatibilizer additive (3) is preferably added to the inherently incompatible mixture of two inherently incompatible polyols in such amounts that mixing with customary mixing appliances establishes monophasicness for the mixture. It is particularly preferable for the added amount of compatibilizer additive to be chosen such that the monophasicness of the mixture thus obtained at least ensures the above-specified storage for one week. It is very particularly preferable for the added amount of compatibilizer additive to be chosen such that the monophasicness of the mixture thus obtained is ensured up to its reactive conversion into a polyurethane.

The copolymers used as compatibilizer additives are more particularly characterized in that in the structural units I to VI
R represents hydrogen or a methyl or ethyl radical,
X represents an —NH—R₁ group or an —OR₁ group, where R₁ represents hydrogen, an alkyl radical of 1 to 6 carbon atoms, an alkylene radical having 1 to 6 carbon atoms and an OH group, preferably as end group, or represents a polyalkylene oxide radical,
Y represents an optionally substituted phenyl, naphthyl or pyrrolidone radical, an ε caprolactam radical, a polyalkylene oxide radical attached via an —O— bridge, or represents an acetate radical,
Z represents a —COOR₁ group, where R₁ is as defined above, or
Z combines with the

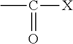

group where X is an —OR₁ group and R₁ represents hydrogen to form a cyclic anhydride grouping or where X is an

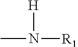

group to form a cyclic imide grouping whose nitrogen is substituted with an R₁ radical as defined above,
X′ represents an

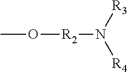

group or a corresponding, quaternized

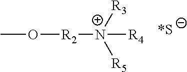

group, represents an

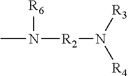

group or a
corresponding, quaternized

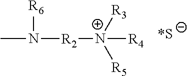

group, where R₂ represents an alkylene radical having 1 to 6 carbon atoms,
R₃, R₄, R₅ or R₆ are the same or different and each represent an alkyl radical of 1-3 carbon atoms or a benzyl radical, where the radicals R₃-R₅ may optionally each be substituted by an —OH group,
S⊖ represents the remaining, anionic radical of the hereinbelow recited alkylating compound (4′), preferably a halide anion and more preferably chloride, bromide or iodide, or represents a sulfate anion or carboxylate anion,
or X′ represents an

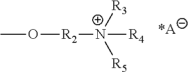

group or a corresponding, salted

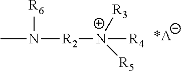

group, where R₂ is as defined above,
R₃, R₄, R₅ and R₆ are each as defined above, but at least one of R₃-R₅ represents hydrogen, and
A⊖ represents the remaining, anionic radical of one of the hereinbelow recited salting compounds (4),
or X′ as an

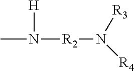

group combines with Z′ as a —COOR₁ group to form a cyclic imide group whose nitrogen is substituted with the

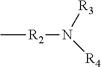

group or one of the corresponding, quaternized or salted groups defined above,
Y′ represents a basic, aliphatic or aromatic, heterocyclic radical having 5-10 ring members and at least one nitrogen atom as ring member, and preferably represents an imidazole, pyrrole, pyrazole, pyrimidine, purine, quinoline or pyridine radical;
Z′, which is identical to or different from X′, represents a grouping having the above meaning of X′ or represents a —COOR₁ group, where R₁ is as defined above,
where the structural units IV to VI are optionally present as preferably up to 75% salted with at least one preferably oligomeric organic compound (4) having at least one acidic group and/or optionally present as quaternized with at least one alkylating compound (4′).

The copolymer used as compatibilizer additive (3) may have a random, gradientlike or blocklike construction of copolymerized structural units which optionally comprises comb structures.

In a preferred embodiment, the compatibilizer additive (3) is a structured copolymer.

Structured copolymers are linear block copolymers, gradient copolymers, branched/star-shaped block copolymers and comb copolymers.

Gradientlike copolymers of the copolymers which are used according to the present invention are copolymers in which, along the polymer chains, the concentration of structural units of a particular ethylenically unsaturated monomer or the structural units of a mixture of ethylenically unsaturated monomers decreases continuously and the concentration of structural units of a different ethylenically saturated monomer or of structural units of a mixture of different ethylenically unsaturated monomers increases.

Disclosure in EP 1 416 019 and WO 01/44389 is referenced as exemplary of gradientlike copolymers.

Block copolymers used according to the present invention are copolymers obtained by adding at least two different ethylenically unsaturated monomers, two different mixtures of ethylenically unsaturated monomers or by adding an ethylenically unsaturated monomer and a mixture of ethylenically unsaturated monomers at different times in the practice of a controlled polymerization wherein an ethylenically unsaturated monomer or a mixture of ethylenically unsaturated monomers is initially charged at the start of the reaction. At the time of adding the further ethylenically unsaturated monomer or the mixture of ethylenically unsaturated monomers or adding ethylenically unsaturated monomers in multiple installments, the ethylenically unsaturated monomers added at the start of the polymerization can be already completely reacted, or still be partly unpolymerized. As a result of such a polymerization, block copolymers have at least one abrupt transition in their structural units along the polymer chain, said transition marking the boundary between the individual blocks.

Such block copolymer structures which may preferably be used are for example AB diblock copolymers, ABA triblock copolymers or ABC triblock copolymers. Examples of producing such block copolymer structures are found in U.S. Pat. No. 6,849,679, U.S. Pat. No. 4,656,226, U.S. Pat. No. 4,755,563, U.S. Pat. No. 5,085,698, U.S. Pat. No. 5,160,372, U.S. Pat. No. 5,219,945, U.S. Pat. No. 5,221,334, U.S. Pat. No. 5,272,201, U.S. Pat. No. 5,519,085, U.S. Pat. No. 5,859,113, U.S. Pat. No. 6,306,994, U.S. Pat. No. 6,316,564, U.S. Pat. No. 6,413,306, WO 01/44389 and WO 03/046029.

Block copolymers which are preferably used according to the present invention contain blocks having a minimum number of 3 structural units per block. The minimum number of structural units per block is preferably 3, more preferably 5 and most preferably 10.

Each of the blocks may contain the same structural units but each in different numbers, or is constructed of different structural units.

In one preferred embodiment, the compatibilizer additive (3) has a block structure of the type A-B, A-B-A, B-A-B, A-B-C and/or A-C-B, in which the A, B and C blocks represent a differing composition of structural units, wherein

the blocks A, B and C differ by their respective composition of structural units I-VI and in which the amount of structural units IV-VI in two adjacent blocks differs from each other by more than 5% by weight in each case.

Particular preference is given to block structures in which

block A contains from 0% to 25% by weight of at least one of structural units IV-VI, optionally at least partly salted or quaternized,

block B contains from 50% by weight to 100% by weight of at least one of structural units IV-VI, optionally at least partly salted or quaternized,

and block C contains from 0% to 75% by weight of at least one of structural units IV-VI, optionally at least partly salted or quaternized,

wherein the weight % ages of structural units IV-VI are based on their basic, i.e., unsalted or unquaternized form.

A very particularly preferred embodiment is characterized in that

block A contains from 0% to 10% by weight of at least one of structural units IV-VI, optionally at least partly salted or quaternized,

block B contains from 75% by weight to 100% by weight of at least one of structural units IV-VI, optionally at least partly salted or quaternized,

and block C contains from 0% to 50% by weight of at least one of structural units IV-VI, optionally at least partly salted or quaternized,

wherein the weight % ages of structural units IV-VI are based on their basic, i.e., unsalted or unquaternized form.

In a preferred overall composition of the copolymer used as compatibilizer additive, the proportion of structural units IV-VI in the unsalted or unquaternized state is from 5% to 95% by weight, preferably from 15% to 60% by weight and even more preferably from 20% to 45% by weight, based on the total weight of copolymer.

The number average molecular weight Mₙ of the polymers according to the present invention is preferably in the range from 1000 to 250 000 g/mol, more preferably in the range from 2000 to 25 000 g/mol and even more preferably in the range from 2500 to 10 000 g/mol.

The determination of molecular weights is done using gel permeation chromatography (GPC) and is more particularly elucidated in the examples.

The copolymers used according to the present invention are notable for at least one of structural units IV to VI, which has a protonatable nitrogenous group as a result of polymerization of a corresponding ethylenically unsaturated monomer, or where such a protonatable nitrogenous group was incorporated in the molecule through chain-analogous reaction.

A protonatable nitrogenous group for the purposes of the present invention is a group in which a nitrogen atom can react in the presence of a proton to form a cation, although this reaction can also precede reversibly as the case may be. This may be diagrammatically illustrated by way of example using the following structures:

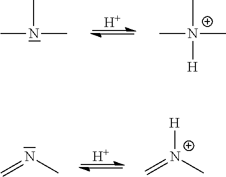

Examples of compounds having protonatable nitrogenous groups are for example compounds having primary, secondary and tertiary amino groups and also compounds having aliphatic or aromatic heterocyclic radicals containing at least one nitrogen atom and optionally further heteroatoms as ring members, such as N-containing aliphatic or aromatic, heterocyclic radicals derived for example from pyrrole, imidazole, pyrazole, pyridine, pyrimidine, pyridazine, pyrazine, dihydropyrrole, pyrroline, pyrrolidine, triazole, isothiazole, oxazole, isoxazole, dihydrooxazole, oxazolane, oxazoline, azepine, piperazine, morpholine, triazine, indole, benzimidazole, quinoline, phenazine, triazole or triazine.

Particular preference is given to monoethylenically unsaturated, aliphatic compounds having primary, secondary and/or tertiary amino groups, the amino groups of which can be substituted with aliphatic and/or aromatic free radicals, preferably C1-C6 alkyl free radicals and/or C6-C10 aryl free radicals, and also further nitrogenous, preferably aromatic heterocycles having 5-6 ring members and derived with particular preference from imidazole or pyridine.

The structural units IV-VI of copolymers used according to the present invention can preferably derive from ethylenically unsaturated, preferably aliphatic monomers having amino groups, and/or vinyl-containing, preferably aromatic heterocycles having at least one protonatable nitrogen atom as ring member. There can be used with particular preference a methacrylic acid derivative—such as a (meth)acrylate or (meth)acrylamide—having at least one amino group, with very particular preference a C1-C6 alkyl (meth)acrylate having at least one amino group such as, for example, N,N-dimethylaminoethyl(meth)acrylate and N,N-dimethylaminopropyl(meth)acrylate, amino-containing C1-C6 alkyl(meth)acrylamides, for example N,N-dimethylaminopropyl(meth)acrylamide, or basic vinyl heterocycles such as, for example 4-vinylpyridine, 2-vinylpyridine or vinylimidazole.

The amino-containing structural units of copolymers used according to the present invention are also obtainable by modification of structural units after their production e.g. by polymerization of oxirane-containing, ethylenically unsaturated monomers such as glycidyl methacrylate for example, and subsequent reaction with appropriate, reactive amines.

Alternatively, esterification/amidation or transesterification/transamidation of structural units of copolymers derived from (meth)acrylic acid, esters and amides or from maleic acid, anhydride or esters with suitable aminoalcohols or polyamino-functional compounds can also be used to incorporate corresponding protonatable nitrogenous groups into the respective copolymers. Examples of this reaction are for example the amidation of structural units derived from (meth)acrylic acid or the amidation of structural units derived from (meth)acrylates with amines such as 3-dimethylaminopropylamine, 3-aminopropylimidazole or amino-substituted pyridines.

Tertiary amines can also be converted with oxygen, peroxo compounds such as, for example, percarboxylic acids or with hydrogen peroxide into amine oxides which can additionally be salted with acids such as hydrochloric acid for example.

The copolymer with protonatable nitrogen atoms which is obtained by polymerizing the ethylenically unsaturated monomers can be at least partially salted and/or quaternized by a method known to a person skilled in the art.

For salting, the structural units with protonatable nitrogenous groups can be reacted with organic compounds (4) having acidic groups and as recited hereinbelow.

Useful compounds (4) for salting the structural units IV-VI can be at least one salt-forming component selected from the group consisting of optionally substituted mono-, bi- or tricyclic sulfonic, carboxylic, phosphonic or phosphoric acids and aliphatic, optionally substituted sulfonic, carboxylic, phosphonic or phosphoric acids or at least one quaternizing compound (4′) selected from the group consisting of active alkyl halides or alkyl esters of sulfuric acid or a system comprising an epoxy compound and a carboxylic acid.

A preferred group of substituted mono-, bi- or tricyclic sulfonic, carboxylic and phosphonic acids are represented by the following formula:

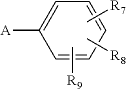

where

A represents a carboxy, sulfone or P(═O) (OH)₂ group and R₇, R₈ or R₉ each independently represent hydrogen or a substituent selected from the group consisting of functional groups or derivatized functional groups selected from the group consisting of hydroxyl, oxo, thio, —NO₂, carboxy, sulfone, carbamoyl, sulfo, sulfamoyl, ammonium, amidino, cyano, formamide and halogen, or

R₇, R₈ or R₉ each independently represent a saturated or unsaturated aliphatic, cycloaliphatic or heterocycloaliphatic groups, carbocyclic or heterocyclic aryl groups, fused carbocyclic, heterocyclic or carbocyclic-heterocyclic groups which can additionally be substituted with one of the functional groups or derivatized functional groups as mentioned above.

Specific salt-forming components selected from the group consisting of mono- or bicyclic sulfonic acids are recited hereinbelow:

3-nitrobenzenesulfonic acid, 4-sulfophthalic acid, 4-chlorobenzenesulfonic acid, 4-hydroxy-3-nitrobenzenesulfonic acid, 4-dodecylbenzenesulfonic acid, 2,5-dihydroxybenzenesulfonic acid, sulfanilic acid, benzene-1,3-disulfonic acid, 3-sulfobenzoic acid, 4-acetylsulfonic acid, 4-succinimidobenzenesulfonic acid, 4-phthalimidobenzenesulfonic acid.

Further suitable sulfonic acids for use as salt-forming components are

(+)-camphor-10-sulfonic acid and isomers, naphthalene-2-sulfonic acid, naphthalenetrisulfonic acid, isomer mixture, for example naphthalene-1,3,6-trisulfonic acid, naphthalene-1-sulfonic acid and isomers, naphthalene-1,5-disulfonic acid and isomers, 8-hydroxyquinolinesulfonic acid.

Also suitable for use as salt-forming components are the following mono- or bicyclic carboxylic acids and phosphoric acids:

phthalic acid, trimellitic anhydride, isophthalic acid, 5-nitroisophthalic acid, 4-nitrobenzoic acid and isomers, benzoic acid 4-sulfamide, 3,5-dinitrobenzoic acid and isomers, 1-naphthylacetic acid, 2-chlorobenzoic acid and isomers, 3-hydroxynaphthoic acid, 2,4-dichlorobenzoic acid and isomers, N-(4-carboxyphenyl)phthalimide, 4-phenylbenzoic acid, 1-naphthoic acid, phthaloylglycine, 3,4,5-trimethoxybenzoic acid, 2,4-dichlorophenoxyacetic acid, 3-phthalimidopropionic acid, 2-phthalimidopropionic acid, 4-methyl-2-phthalimidovaleric acid, 2-phthalimidoisovaleric acid, 2-phthalimidobutyric acid, phthalimidosuccinic acid, 2-phthalimidoglutaric acid, 2-phthalimidobenzoic acid, 2,4,6-trichlorophenoxyacetic acid, 2-(2,4-dichlorophenoxy)propionic acid, 4-(2,4-dichlorophenoxy)butyric acid, 3-(2,4-dichlorobenzoyl)-propionic acid, 3-(2,4-dichlorobenzoyl)butyric acid, 2,4-dichlorophenylacrylic acid, 3-(4,5-dichlorophthalimido)benzoic acid, 2-tetrachlorophthalimidobenzoic acid, 3-tetrachlorophthalimidobenzoic acid.

These recited organic compounds having at least one carboxylic acid, sulfonic acid, phosphonic acid and/or phosphoric acids group may preferably also be used as ester compounds. These ester compounds may be oligomeric or polymeric and may include at least one more carboxylic, sulfonic, phosphonic and/or phosphoric acid grouping.

Corresponding compounds are

phosphoric esters of formula: (HO)₃₋ₙPO(OR₁₀)ₙ with n=1 or 2, or

phosphonic esters of formula R₁₃PO(OH)(OR₁₀),

sulfonic acids of general formula HOSO₂R₁₁,

acidic sulfuric esters of formula HOSO₃R₁₁,

where R₁₀ and R₁₁, which are the same or different, represent an alkyl, aryl or aralkyl radical having at least 5 carbon atoms and/or a radical of an alkoxylated alcohol having a number average molecular weight to 5000 g/mol, and/or a radical having at least one carboxylic ester group having a number average molecular weight to 5000 g/mol or a polyether polyester radical, preferably having a number-averaged molecular weight to 5000 g/mol, or a mixture of such compounds; R₁₃, the same or different in each occurrence, has the meaning of R₁₀ or represents hydrogen.

In one preferred embodiment, salting is effected using carboxylic, sulfonic, phosphonic and/or phosphoric polymeric esters which preferably derive from polyalkylene oxides. Particular preference is given to carboxylic and/or phosphoric polymeric esters obtained by reaction of polyalkylene oxides derived from alkylene oxides having 1-4 carbon atoms, preferably from ethylene oxide and/or propylene oxide, and which preferably have between 3-15 recurring units of the alkylene oxide.

Very particular preference is given to using carboxylic and phosphoric, polymeric polyalkylene oxides, preferably from ethylene oxide and/or propylene oxide for salting, which are additionally connected at least via an ether bond to a C₁-C₂₄ alcohol or additionally via an ester bond to a fatty acid radical. The acidic groups of these acidic polymeric esters are more preferably present here in the form of acidic di- and tricarboxylic partial esters, for example acidic dicarboxylic acid monoesters as for example of succinic acid, maleic acid or phthalic acid, or in the form of the mono- or diesters of trimellitic acid. Corresponding carboxylic polymeric esters are obtainable by reaction of alkyl, aryl, aralkyl or alkylaryl alkoxylates such as, for example, nonylphenol ethoxylates, isononyl alcohol ethoxylates, isotridecyl alcohol ethoxylates or butanol- or methanol-initiated alkylene oxide polyethers with di- and tricarboxylic acids or derivatives thereof (e.g., anhydride, halide).

Alternatively, phosphorylation products of these alkoxylates can be used as phosphoric polymeric esters.

Alternatively or additionally to salting with the acid components described above, the protonatable nitrogenous groups of copolymers according to the present invention can also be quaternized using an alkylating reaction with, for example, active, optionally substituted alkyl halides, e.g., methyl iodide, methyl chloride or benzyl chloride, with dialkyl sulfates such as, for example, C₁-C₆-dialkyl sulfates or with an oxirane compound in the presence of a carboxylic acid.

The copolymers used according to the present invention may have not only salted but also quaternized structural units in any one copolymer. But it is also possible to use a mixture of an at least partially salted copolymer with an at least partially quaternized copolymer as compatibilizer additive.

Using already salted or quaternized (either by protonation or by alkylation) amino-containing ethylenically unsaturated monomers makes it possible to obtain the structural units IV-VI in their salted and/or quaternized form also by direct polymerization of salted and/or quaternized monomers.

Examples of such monomers which can be used direct for polymerization are, for example, 2-trimethylammonium ethyl(meth)acrylate chloride, 3-trimethylammonium propyl(meth)acrylamide chloride and 2-benzyldimethylammonium methyl(meth)acrylate chloride.

The copolymers used according to the present invention, especially of structural units I-III, are preferably obtainable using the following ethylenically unsaturated monomers: alkyl(meth)acrylates of straight-chain, branched or cycloaliphatic alcohols having 1 to 22 carbon atoms, for example methyl (meth)acrylate, ethyl(meth)acrylate, n-butyl (meth)acrylate, i-butyl(meth)acrylate, t-butyl (meth)acrylate, lauryl(meth)acrylate, 2-ethylhexyl (meth)acrylate, stearyl(meth)acrylate, tridecyl (meth)acrylate, cyclohexyl(meth)acrylate, isobornyl (meth)acrylate, allyl(meth)acrylate and t-butyl (meth)acrylate; aryl(meth)acrylates, e.g., benzyl (meth)acrylate or phenyl(meth)acrylate, wherein the aryl radicals may each be unsubstituted or substituted up to four times, for example 4-nitrophenyl methacrylate; hydroxyalkyl(meth)acrylates of straight-chain, branched or cycloaliphatic diols having 2 to 36 carbon atoms, for example 3-hydroxypropyl methacrylate, 3,4-dihydroxybutyl monomethacrylate, 2-hydroxyethyl (meth)acrylate, 4-hydroxybutyl(meth)acrylate, 2-hydroxypropyl methacrylate, 2,5-dimethyl-1,6-hexanediol monomethacrylate, hydroxyphenoxypropyl methacrylate; mono(meth)acrylates of oligomeric or polymeric ethers, e.g., polyethylene glycols, polypropylene glycols or mixed polyethylene/propylene glycols, polyethylene glycol) methyl ether (meth)acrylate, poly(propylene glycol) methyl ether (meth)acrylate having 5 to 80 carbon atoms, methoxyethoxyethyl (meth)acrylate, 1-butoxypropyl(meth)acrylate, cyclohexyloxymethyl(meth)acrylate, methoxymethoxyethyl (meth)acrylate, benzyloxymethyl(meth)acrylate, furfuryl(meth)acrylate, 2-butoxyethyl(meth)acrylate, 2-ethoxyethyl(meth)acrylate, allyloxymethyl (meth)acrylate, 1-ethoxybutyl(meth)acrylate, 1-ethoxyethyl (meth)acrylate, ethoxymethyl(meth)acrylate, caprolactone- and/or valerolactone-modified hydroxyalkyl(meth)acrylates having a number average molecular weight Mₙ of 220 to 1200, wherein the hydroxy (meth)acrylates are preferably derived from straight-chain, branched or cycloaliphatic diols having 2 to 8 carbon atoms; (meth)acrylates of halogenated alcohols, for example perfluoroalkyl(meth)acrylates having 6 to carbon atoms; oxirane-containing (meth)acrylates, for example 2,3-epoxybutyl methacrylate, 3,4-epoxybutyl methacrylate and glycidyl(meth)acrylate; styrene and substituted styrenes, for example α-methylstyrene or 4-methylstyrene; methacrylonitrile and acrylonitrile; vinyl-containing, nonbasic heterocycles, for example 1-[2-(methacryloyloxy)ethyl]-2-imidazolidine and N-vinylpyrrolidone, N-vinylcaprolactam; vinyl esters of carboxylic acids having 1 to 20 carbon atoms, for example vinyl acetate; maleic acid, maleic anhydride, maleic monoesters and maleic diesters; maleimide, N-phenylmaleimide and N-substituted maleimides having straight-chain, branched or cycloaliphatic alkyl groups having 1 to 22 carbon atoms, for example N-ethylmaleimide and N-octylmaleimide; (meth) acrylamide; N-alkyl- and N,N-dialkyl-substituted acrylamides having straight-chain, branched or cycloaliphatic alkyl groups having 1 to 22 carbon atoms, for example N-(t-butyl)acrylamide and N,N-dimethylacrylamide; silyl-containing (meth)acrylates, for example trimethylsilyl (meth)acrylate and 3-(trimethylsilyl)propyl methacrylate.

After polymerization has taken place, the structural units deriving from these ethylenically unsaturated monomers can be further modified. For instance, oxirane structures can be reacted with nucleophilic compounds, such as 4-nitrobenzoic acid. Hydroxyl groups can be reacted with lactones, for example ε-caprolactone, to form polyesters; and OH groups can be released from ester groups by acid- or base-catalyzed ester cleavage.

Preferably, the compatibilizer additive (3) is a structured copolymer and more preferably a block, gradient or comb copolymer, preferably produced by a controlled free-radical or ionic process of polymerization.

It is particularly preferable to produce such compatibilizer additives (3) through controlled free-radical polymerization or group transfer polymerization.

Depending on which of the polymerization techniques recited hereinbelow is used, different copolymers are obtained even when identical ethylenically unsaturated monomers are used and even at the same molar ratios, since the different polymerization techniques can lead to different microstructures or to be more precise to different sequences of structural units I-VI. For instance, block copolymers produced by different techniques from identical monomer mixtures will be obtained with differently microstructured blocks. In addition, the copolymers can also differ distinctly in respect of their molecular weight and their molecular weight distribution. The same holds for gradientlike copolymers.

Various processes are known in the literature for conducting a controlled polymerization. An overview of some processes is found in Prog. Polym. Sci. 32 (2007) 93-146.

As polymerization techniques to produce the copolymers used as compatibilizer additive in the compositions of the invention there can be used any prior art polymerization technique for polymerizing ethylenically unsaturated monomers.

Some technologies for conducting controlled polymerizations will now be mentioned by way of example.

Atom transfer radical polymerization (ATRP) provides a controlled polymerization and is described for example in Chem. Rev. 2001, 101, 2921 and in Chem. Rev. 2007, 107, 2270-2299.

The controlled methods of polymerization also include the reversible addition fragmentation chain transfer process (RAFT) which, when certain polymerization regulators are used, is also known as MADIX (macromolecular design via the interchange of xanthates) and addition fragmentation chain transfer. RAFT is described for example in Polym. Int. 2000, 49, 993, Aust. J. Chem. 2005, 58, 379, J. Polym. Sci. Part A: Polym. Chem. 2005, 43, 5347, Chem. Lett. 1993, 22, 1089, J. Polym. Sci., Part A 1989, 27, 1741 and also 1991, 29, 1053 and also 1993, 31, 1551 and also 1994, 32, 2745 and also 1996, 34, 95 and also 2003, 41, 645 and also 2004, 42, 597 and also 2004, 42, 6021 and in Macromol. Rapid Commun. 2003, 24, 197, in Polymer 2005, 46, 8458-8468 and also in Polymer 2008, 49, 1079-1131 and in U.S. Pat. No. 6,291,620, WO 98/01478, WO 98/58974 and WO 99/31144.

A further process for controlled polymerization utilizes nitroxyl compounds as polymerization regulators (NMP) and is disclosed for example in Chem. Rev. 2001, 101, 3661.

A further controlled method of polymerization is group transfer polymerization (GTP) as disclosed for example in O. W. Webster in “Group Transfer Polymerization”, in “Encyclopedia of Polymer Science and Engineering”, volume 7, H. F. Mark, N. M. Bikales, C. G. Overberger and G. Menges, Eds., Wiley Interscience, New York 1987, page 580 ff., and also in O. W. Webster, Adv. Polym. Sci. 2004, 167, 1-34.

The controlled free-radical polymerization with tetraphenylethane as described in Macromol. Symp. 1996, 111, 63 for example is a further example of controlled polymerizations.

The controlled free-radical polymerization with 1,1-diphenylethene as polymerization regulator is described for example in Macromolecular Rapid Communications, 2001, 22, 700.

The controlled free-radical polymerization with iniferters is disclosed for example in Makromol. Chem. Rapid. Commun. 1982, 3, 127.

The controlled free-radical polymerization with organocobalt complexes is known for example from J. Am. Chem. Soc. 1994, 116, 7973, from Journal of Polymer Science: Part A: Polymer Chemistry, Vol. 38, 1753-1766 (2000), from Chem. Rev. 2001, 101, 3611-3659 and also from Macromolecules 2006, 39, 8219-8222.

A further controlled technique of polymerization is degenerative chain transfer with iodine compounds as described for example in Macromolecules 2008, 41, 6261, in Chem. Rev. 2006, 106, 3936-3962 or in U.S. Pat. No. 7,034,085.

The controlled free-radical polymerization in the presence of thioketones is described for example in Chem. Commun. 2006, 835-837 and in Macromol. Rapid Commun. 2007, 28, 746-753.

More particularly, the preferably structured copolymers are obtainable using any prior art living controlled techniques of polymerization such as for example ATRP, RAFT, MADIX, NMP, GTP, the controlled free-radical polymerization with tetraphenylethane, the controlled free-radical polymerization with 1,1-diphenylethene, the controlled free-radical polymerization with iniferters, the controlled free-radical polymerization in the presence of thioketones and the controlled free-radical polymerization with organocobalt complexes.

The initiators used in the particular polymerization process are known to a person having ordinary skill in the art. Free-radical polymerization processes for example can utilize not only azo initiators such as azobisisobutyronitrile, peroxy compounds, such as dibenzoyl peroxide and dicumyl peroxide, but also persulfates such as ammonium peroxodisulfate, sodium peroxodisulfate and potassium peroxodisulfate.

Similarly, the initiators, polymerization regulators and catalysts used for the living controlled polymerization processes are known to a person having ordinary skill in the art.

Initiators for atom transfer radical polymerization are for example

haloalkanes having 1 to 10 carbon atoms, such as carbon tetrabromide and 1,1,1-trichloroethane;

haloalcohols having 2 to 10 carbon atoms, such as 2,2,2-trichloroethanol;

2-halo carboxylic acid and esters having 2 to 20 carbon atoms, such as chloroacetic acid, 2-bromopropionic acid, methyl 2-bromopropionate, methyl 2-chloropropionate, ethyl 2-bromoisobutyrate and ethyl 2-chloroisobutyrate;

2-halo carbonitriles having 2 to 10 carbon atoms, such as 2-chloroacetonitrile and 2-bromopropionitrile; alkyl and aryl sulfonyl chlorides having 2 to 10 carbon atoms, such as methanesulfonyl chloride and benzenesulfonyl chloride; and

1-aryl-1-haloalkanes having 7 to 20 carbon atoms, for example benzyl chloride, benzyl bromide and 1-bromo-1-phenylethane.

Catalysts for ATRP are for example copper chloride or bromide complexes of nitrogenous ligands such as 2,2′-bipyridine or N,N,N′,N″,N″-pentamethyldiethylenetriamine, which can also be generated in situ from copper metal, ligand and initiator. Further catalysts are recited in Chem. Rev. 2001, 101, 2921 and in Prog. Polym. Sci 32 (2007) 93-146 and also in Chem. Rev. 2007, 107, 2270-2299.

It is also prior art for some polymerization processes to utilize adducts of the initiator with the polymerization regulator, for example alkoxyamines for the NMP process. Examples thereof are recited in Chem. Rev. 2001, 101, 3661, “V. Approaches to Alkoxyamines” or in Angewandte Chemie Int. Ed. 2004, 43, 6186. It is further possible to form initiators/regulators in situ as described for example in Macromol. Rapid Commun. 2007, 28, 147 for the NMP process. Further examples of initiators/regulators for the NMP process are for example 2,2,6,6-tetramethylpiperidine oxyl (TEMPO) or N-tert-butyl-N-[1-diethylphosphono-(2,2-dimethylpropyl)]nitroxyl and also the compounds recited in WO 96/24620 and DE 60 2004 008967.

The GTP process utilizes silylketene acetals such as, for example, [(1-methoxy-2-methyl-1-propenyl)oxy]-trimethylsilane as initiators. Further examples are found in U.S. Pat. No. 4,822,859, U.S. Pat. No. 4,780,554 and EP 0184692 B1. GTP employs fluorides described in U.S. Pat. No. 4,659,782 and oxyanions described in U.S. Pat. No. 4,588,795 as catalysts. A preferred catalyst for GTP is tetrabutylammonium m-chlorobenzoate.

Regulators for the RAFT process include for example thiocarboxylic esters, thiocarbamates or xanthic esters, which are often used in combination with free-radical initiators such as, for example, azo initiators, peroxy compounds or persulfates.

Catalysts for controlled free-radical polymerization with organocobalt complexes are recited for example in Chem. Rev. 2001, 101, 3611.

Further examples of initiators, polymerization regulators and catalysts used for the living controlled polymerization processes are mentioned in the above-cited literature concerning the polymerization techniques. The use of so-called dual- or heterofunctional initiators, described in Prog. Polym. Sci. 31 (2006) 671-722 for example, is also possible.

The recited polymerizations can be carried out in organic solvents and/or water or without a solvent. When solvents are used, the polymerization can be carried out as a classic solvent polymerization, wherein the polymer is dissolved in solvent, or as an emulsion or miniemulsion polymerization, as described for example in Angewandte Chemie Int. Ed. 2004, 43, 6186 and Macromolecules 2004, 37, 4453. The emulsion or miniemulsion polymer obtained can be water-solubilized by salt formation, so that a homogeneous solution of polymer is produced. However, the copolymers may still be water-insoluble after salting.

The copolymers obtained here are not necessarily defined via the polymerization regulator as end group. The end group can for example be wholly or partly detached after polymerization. For instance, the nitroxyl end group of copolymers produced via NMP can be detached thermally by raising the temperature above the polymerization temperature. This detaching of polymerization regulator can also be accomplished for example by adding further chemical compounds such as polymerization inhibitors, for example phenol derivatives, or by a process as described in Macromolecules 2001, 34, 3856.

A sulfur-containing RAFT regulator can be detached from the copolymer thermally by raising the temperature, by addition of oxidizing agents such as hydrogen peroxide, peracids, ozone or other bleaching agents, or be reacted with nucleophiles such as amines to form a thiol end group.

Furthermore, the halogen end groups generated by ATRP can be detached by elimination reactions or converted into other end groups by substitution reactions. Examples of such transformations are recited in Chem. Rev. 2001, 101, 2921.

The present invention further provides for the production of copolymers used according to the present invention by a living controlled free-radical polymerization or by group transfer polymerization.

The copolymers thus obtained are very useful for ensuring the compatibility of inherently incompatible polyols as reaction components for the production of polyurethanes.

The incompatibility of polyol component (1) with polyol component (2) can be occasioned inter alia by their different molecular weights, their different constructions and/or their different polarities.

It is accordingly well known that oligomeric or polymeric polyalkylene oxide polyols are incompatible with short-chain polyols. Also prone to separation are polyols of isocyanate-reactive, oligomeric or polymeric polyalkylene oxides when they are constructed from different alkylene oxides or include different proportions of the same type of alkylene oxides, e.g., polyethylene oxides and polypropylene oxides having comparable molecular weights, or polyethers formed from ethylene oxide and propylene oxide which each have approximately the same number of structural units but different proportions of ethylene oxide and propylene oxide.

The same holds for polyester or polyether-polyester polyols.

The employed compatibilizer additive (3) of the present invention remedies such various caused separation tendencies and ensures monophasic compositions for polyol components (1) and (2) up to the time of their further reactive conversion with the polyisocyanate component, at least one week at 40° C. from the time of their being mixed with the compatibilizer additive (3).

The polyol component (1) contains at least one polyol of general formula

HO—B*—OH,

where B* represents a divalent free radical selected from the group comprising
(i) alkylene free radicals having 2 to 8 carbon atoms;
(ii) free radicals of formula —CH₂—B′—CH₂—, in each of which B′ represents one of the groups 1a)-5a)

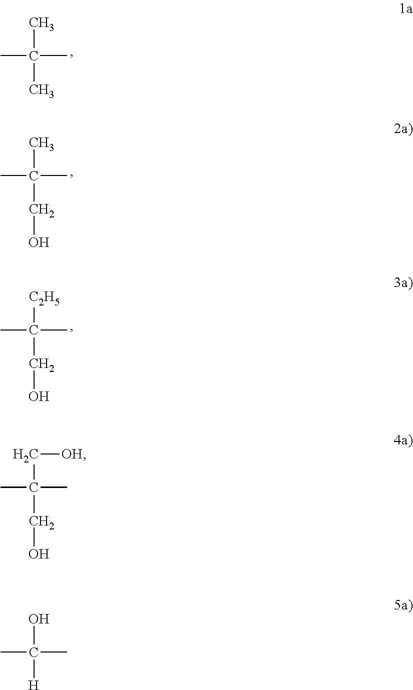

(iii) free radicals of structural formula —(B″—O)ₙ—B″—, where B″ is an alkylene free radical having 2 to 4 carbon atoms and n is an integer from 1 to 20 and preferably from 1 to 10, and
(iv) a radical derived from a polyether, polyester or polyether-polyester.

A particularly preferred composition according to the present invention is a composition in which the polyol component (1) includes a C₂H₄ or C₄H₈ or C₆H₁₂ or C₈H₁₆ group as B* group or the group B′ is a CH(OH) radical.

What are known as chain extenders are preferably concerned here, i.e., short-chain aliphatic polyols and more preferably aliphatic polyols having 2 to 8 carbon atoms, such as ethylene glycol, butanediol, hexanediol, octanediol and glycerol.

A polyether polyol or polyester polyol is a further particularly preferred variant for polyol component (1).

The second isocyanate-reactive polyol component (2) is preferably a polyalkylene oxide having hydroxyl groups and more preferably a polyalkylene oxide deriving from alkylene oxides having 2 to 4 carbon atoms, preferably from ethylene oxide and/or propylene oxide. These polyalkylene oxides have 2, 3 or more terminal hydroxyl groups and 5 to 100 alkylene oxide units, depending on whether they were initiated using a low molecular weight diol, glycerol or more hydric alcohol; in special cases, the polyalkylene oxides may also be initiated using amines, for example aliphatic diamines. When the comparatively high molecular weight polyol component is constructed not just from a particular alkylene oxide, the polyalkylene oxide in question can have a random or blocklike construction, and in this blocklike construction randomly constructed blocks and blocks constructed of just one particular alkylene oxide at a time can alternate.

Preference for use as polyol component (2) is further given to polyester polyols and/or polyether/polyester polyols.

A particularly preferred combination of inherently incompatible polyol components (1) and (2) is a short-chain aliphatic diol or glycerol mixed with a polyether, polyester or polyether/polyester polyol.

Preference is similarly given to a mixture of mutually incompatible polyether polyols with polyester polyols or different polyether polyols or different polyester polyols or different polyether/polyester mixtures.

The compatibilizer additive (3), which is preferably in liquid form such as a liquid per se or in dissolved form, provides the inherently incompatible polyol mixture—by simply admixing and single commixing—with an extension in the period of phase separation up to the time when the polyols are reacted to form polyurethanes.

The added copolymer in the polyol mixture obtained is preferably not present therein in the form of solid particles.

To produce the compositions of the present invention, the polyol component (1) and the polyol component (2), which is inherently incompatible therewith, are homogenized in the presence of compatibilizer additive (3), preferably by shaking or stirring. Any customary auxiliary agents and/or addition agents used in the production of polyurethanes can already be mixed in at this stage, if required. Alternatively, these agents can also be added at a later date, directly before the conversion into polyurethanes.

Examples of such auxiliary and addition agents are catalysts and accelerants (for example in the form of basic compounds such as tertiary amines or in the form of organometallic compounds such as organotins), expanding agents (physical expanding agents such as, for example, hydrocarbons or halogenated hydrocarbons and also chemical expanding agents such as, for example, water or carboxylic acids), foam stabilizers, antifoams, deaerators, viscosity reducers, thixotropic agents, heat stabilizers, flame retardants, wetting and dispersing agents, stabilizers (e.g., UV stabilizers and other photoprotectants, hydrolysis stabilizers), oxidation inhibitors, dyes, pigments, organic or inorganic fillers, process additives, adhesion promoters, release agents, plasticizers, antistats, solvents.

In a preferred embodiment of compositions according to the present invention based on 100% by weight formed from components (1)-(3) the proportions are

polyol component (1) 1% to 99% by weight, polyol component (2) 1% to 99% by weight and compatibilizer additive (3) 0.1 to 10% by weight

subject to the proviso that the amount of components (1)-(3) must always sum to 100% by weight.

In a particularly preferred composition according to the present invention based on 100% by weight formed from polyol component (1), polyol component (2) and compatibilizer additive (3), the proportion of compatibilizer additive (3) is from 0.25% by weight to 5% by weight and more preferably from 0.5% to 4% by weight.

The compositions of the present invention can be used as stable polyol component for production of polyurethanes by reaction thereof with organic polyisocyanate compounds in the presence of suitable catalysts.

Examples of suitable organic polyisocyanates are organic compounds having two or more isocyanate groups. These compounds are known for production of polyurethanes. Suitable organic polyisocyanates comprise hydrocarbon diisocyanates, such as alkylene and arylene diisocyanates, and also known triisocyanates. Suitable polyisocyanates are, for example, 1,2-diisocyanatoethane, 1,3-diisocyanatopropane, 1,2-diisocyanatopropane, 1,4-diisocyanatobutane, 1,5-diisocyanatopentane, 1,6-diisocyanatohexane, bis(3-isocyanatopropyl)ether, bis(3-isocyanatopropyl)sulfide, 1,7-diisocyanatoheptane, 1,5-diisocyanato-2,2-dimethylpentane, 1,6-diisocyanato-3-methoxyhexane, 1,8-diisocyanatooctane, 1,5-diisocyanato-2,2,4-trimethylpentane, 1,9-diisocyanatononane, 1,10-diisocyanatopropyl ether of 1,4-butylene glycol, 1,11-diisocyanatoundecane, 1,12-diisocyanatododecane, bis(isocyanatohexyl)sulfide, 1,4-diisocyanatobenzene, 2,4-diisocyanatotoluene, 2,6-diisocyanatotoluene, 2,4-diisocyanato-1-chlorobenzene, 2,4-diisocyanato-1-nitrobenzene and 2,5-diisocyanato-1-nitrobenzene and also mixtures thereof. Further suitable compounds comprise 4,4-diphenylmethane diisocyanate, 1,5-naphthylene diisocyanate, isophorone diisocyanate and 1,4-xylylene diisocyanate. Suitable compounds also include the modified liquid MDI isocyanates of U.S. Pat. No. 3,384,653 and various quasi prepolymers of U.S. Pat. Nos. 3,394,164, 3,644,457, 3,457,200 and 3,883,571.

Particularly preferred polyisocyanates are tolylene diisocyanate, diphenylmethyl diisocyanate (in the form of “monomer MDI” or “polymer MDI”), isophorone diisocyanate, hexamethylene diisocyanate and also oligomers thereof.

Suitable catalysts and/or foaming agents are discernible from German laid-open document DOS 2730374.

The production of polyurethanes by reacting the compositions of the present invention as phase separation stabilized polyol components with polyisocyanates can be used to produce polyurethane foams as well as to produce unfoamed polyurethane materials (CASE applications); the production of polyurethanes is literature known and is described for example in R. Leppkes, “Die Bibliothek der Technik, Bd. 91: Polyurethane”, Verlag moderne Industrie, Landsberg/Lech 1993, and also in R. Herrington, K. Hock, “Flexible Polyurethane Foams”, Dow Chemical Comp., Midland (USA) 1997, and also in S. Lee, “The Huntsman Polyurethanes Book”; Huntsman Int. LLC, 2002, and also in U. Meier-Westhues, “Polyurethane—Lacke, Kleb- and Dichtstoffe”, Vincentz Network, 2007, and also in G. Oertel, “Kunststoffhandbuch, Bd. 7: Polyurethane”, Hanser Fachbuch, 2004, and also in K. Uhlig, “Polyurethan-Taschenbuch”, Hanser Fachbuchverlag, 2005.

The present invention accordingly also provides for the use of compositions of the present invention as a phase separation stabilized polyol component for production of polyurethanes and also a process for production of polyurethanes where in each case the compositions of the present invention, which comprise phase separation stabilized polyol mixtures, are made to react with organic polyisocyanates in the presence of catalysts.

The present invention also provides polyurethane masses, polyurethane bodies and/or polyurethane foams obtained using a composition of the present invention, comprising a phase separation stabilized polyol mixture, by reaction with organic polyisocyanates in the presence of catalysts.

### EXAMPLES

| Designation | Explanation |
|---|---|
| Polyether A | C₁₃/C₁₅-alcohol-initiated polyethylene |
| | oxide, on average 8 recurring ethylene |
| | oxide units |
| Polyether B | C₁₃/C₁₅-alcohol-initiated polyethylene |
| | oxide, on average 11 recurring ethylene |
| | oxide units |
| Esterol C | Hydroxypropyl methacrylate |
| Esterol D | Hydroxyethyl acrylate-initiated |
| | polyester of ε-caprolactone (GPC data: |
| | Mₙ = 590, M_{w}/Mₙ = 1.35) |
| Polyol X | Diprane C58/45, a commercially available |
| | polyol system from Dow-Hyperlast |
| | (Britain) for use in cast- and sprayable |
| | polyester-based polyurethane systems |

Molecular weights were determined using gel permeation chromatography (GPC).

Calibration is by polystyrene standards having a molecular weight of Mₚ 1 000 000 to 162.

Tetrahydrofuran for analysis is used as eluent.

The following parameters are observed in the duplicate measurement:

Degassing: online degasser
Flow rate: 1 ml/min
Analysis time: 45 minutes
Detectors: refractometer and UV detector
Injection volume: 100 μl-200 μl

The molar mass averages M_{w}; Mₙ and Mₚ and also the polydispersity M_{w}/Mₙ are computed with software support. Baseline points and evaluation limits are fixed in line with German standard specification DIN 55672 Part 1.

### I Production of Compatibilizer Additives

### Production of Copolymer 1

In a three-neck flask equipped with stirrer, reflux condenser and gas inlet, 69.70 g of 1-methoxy-2-propyl acetate are initially charged and mixed with 7.70 g of butyl methacrylate at 20° C. under nitrogen. Then, 3.75 g of 1-trimethylsiloxy-1-methoxy-2-methylpropene and 0.375 g of tetrabutylammonium m-chlorobenzoate are added by injection through a septum. Within 30 min, 60.00 g of butyl methacrylate are metered in. The reaction temperature climbs up to 40° C. and is maintained at that level by cooling. Following the addition of butyl methacrylate 32.80 g of N,N-dimethylaminoethyl methacrylate are metered in during 20 min while cooling is again used to ensure that the temperature does not rise above 40° C. After stirring for 30 min, 3 ml of ethanol are added. The monomers were fully converted (residual monomer content determined via HPLC); product: Mₙ=9100 g/mol as per GPC.

### Production of Copolymer 2

In a three-neck flask equipped with stirrer, reflux condenser and gas inlet, 47.2 g of 1-methoxy-2-propyl acetate and 3.81 g of 2-[N-tert-butyl-N-[1-diethylphosphono-(2,2-dimethylpropyl)]nitroxy]-2-methylpropanoic acid and also 46.00 g of butyl acrylate are initially charged to a three-neck round flask and heated to 120° C. under nitrogen. Stirring is continued at 120° C. for 2.5 h.

Thereafter, 21.00 g of N,N-dimethylaminoethyl methacrylate are added at a rate of 2 ml/min. This is followed by a further 6 h of stirring at 120° C.; the conversion thereafter is above 98% (residual monomer content determined by HPLC); product: Mₙ=3000 g/mol as per GPC.

### Production of Acid 1

In a three-neck flask equipped with stirrer, reflux condenser and gas inlet, 266.60 g of polyether A and 46.60 g of maleic anhydride together with 0.18 g of potassium carbonate are heated to 80° C. and stirred for 4 h under nitrogen. In the process, the color changes from colorless to brown. A monoester of maleic acid is obtained.

### Production of Acid 2

In a three-neck flask equipped with stirrer, reflux condenser and gas inlet, 1414.06 g of polyether B and 200.23 g of maleic anhydride together with 84.98 g of 1-methoxy-2-propyl acetate and 0.73 g of potassium carbonate are heated to 80° C. and stirred for 4 h under nitrogen. In the process, the color changes from colorless to brown. A monoester of maleic acid is obtained.

### Production of Acid 3

In a three-neck flask equipped with stirrer, reflux condenser and gas inlet, 100.00 g of polyether A, 34.12 g of trimellitic anhydride and 0.134 g of p-toluenesulfonic acid are stirred at 170° C. for 5 h under nitrogen.

### Producing a Salt of Copolymer 1 (=Polymer 3)

In a three-neck flask equipped with stirrer, reflux condenser and gas inlet, 50.32 g of the solution obtained in the production of copolymer 1 (containing 30.19 g of copolymer in 20.13 g of 1-methoxy-2-propyl acetate) and also 49.68 g of the solution obtained in the production of acid 2 (containing 47.20 g of polymeric acid and 2.48 g of 1-methoxy-2-propyl acetate) are stirred at 120° C. for 3 h under nitrogen.

### Producing a Salt of Copolymer 2 (=Polymer 4)

In a three-neck flask equipped with stirrer, reflux condenser and gas inlet, 50.32 g of the solution obtained in the production of copolymer 2 (containing 30.19 g of copolymer in 20.13 g of 1-methoxy-2-propyl acetate) and also 49.68 g of the solution obtained in the production of acid 2 (containing 47.20 g of polymeric acid and 2.48 g of 1-methoxy-2-propyl acetate) are stirred at 120° C. for 3 h under nitrogen.

### Producing a Salt of Copolymer 1 (=Polymer 5)

In a three-neck flask equipped with stirrer, reflux condenser and gas inlet, 20.00 g of the solution obtained in the production of copolymer 1 (containing 12.0 g of copolymer in 8.0 g of 1-methoxy-2-propyl acetate) and also 16.00 g of acid 1 are stirred at 120° C. for 3 h under nitrogen.

### Producing a Salt of Copolymer 2 (=Polymer 6)

In a three-neck flask equipped with stirrer, reflux condenser and gas inlet, 20.00 g of the solution obtained in the production of copolymer 2 (containing 12.0 g of copolymer in 8.0 g of 1-methoxy-2-propyl acetate) and also 16.00 g of acid 1 are stirred at 120° C. for 3 h under nitrogen.

### Producing a Salt of Copolymer 1 (=Polymer 7)

In a three-neck flask equipped with stirrer, reflux condenser and gas inlet, 20.00 g of the solution obtained in the production of copolymer 2 (containing 12.0 g of copolymer in 8.0 g of 1-methoxy-2-propyl acetate) and also 45.00 g of acid 3 are stirred at 120° C. for 3 h under nitrogen.

Production of Polymer 8 (as per U.S. Pat. No. 5,344,584, Comparative Example)

In a three-neck flask equipped with stirrer, reflux condenser and gas inlet, 612.90 g of ε-caprolactone are initially charged and stirred at 80° C. for 1 hour under nitrogen. Then, 100.00 g of 2-butyl-1-octanol and 0.14 g of a 10% solution of dibutyltin dilaurate in xylene are added before stirring at 160° C. for 5 h. The mixture is allowed to cool down to 20° C., and a waxy substance is formed.

100 g of the reaction product obtained are removed and heated to 80° C. in a three-neck flask equipped with stirrer, reflux condenser and gas inlet under nitrogen. Within 30 min, 8.50 g of polyphosphoric acid are added. Stirring is continued at 80° C. for a further 4 h. On cooling to 20° C. a waxy substance is obtained.

### II Performance Examples

### General Procedure for Separation Test:

64.0 g of polyol X and 16.0 g of 1,4-butanediol are mixed in a beaker. The compatibilizer additive quantity reported in table 1 is added. Thereafter, the mixture is homogenized with a dissolver (toothed disk, 40 mm diameter, 930 revolutions per minute) for 120 seconds and subsequently transferred into a cylindrical, sealable 100 ml glass vessel (diameter: 3.5 cm, height: 14 cm).

Storage takes place at 40° C. in the sealed vessel. After certain time intervals, the mixture is visually examined for onset of separation. A second phase forms at the surface of the liquid mixture.

TABLE 1

| Additive | Additive | After | After | After | After | After |
|---|---|---|---|---|---|---|
| No. | quantity^{a} | 36 h | 3 days | 7 days | 14 days | 21 days |
| Control | 0 | ◯ | − | − | − | − |
| Polymer 3 | 2.42 g | ++ | ++ | ++ | ++ | ++ |
| Polymer 4 | 2.42 g | ++ | ++ | ++ | ++ | ++ |
| Polymer 5 | 2.42 g | ++ | ++ | ++ | ++ | + |
| Polymer 6 | 2.42 g | ++ | ++ | ++ | ++ | ++ |
| Esterol C^{b} | 2.42 g | + | + | ◯ | ◯ | ◯ |
| Esterol D^{b} | 2.42 g | ◯ | − | − | − | − |
| Polymer 8^{c} | 2.42 g | n.d.* | n.d.* | n.d.* | n.d.* | n.d.* |

^{a}the amount used, based on the amounts of polyol X and 1,4-butanediol indicated in the general procedure; the 2.42 g of additive substance of polymer 3 to polymer 6 each correspond to 3.12 g of the copolymers obtained in the inventive examples as solutions in 1-methoxy-2-propyl acetate.
^{b}as per U.S. Pat. No. 4,673,696
^{c}as per U.S. Pat. No. 5,344,584
*could not be determined since the addition of polymer 8 led to thickening of the system
Explanation:
++ no separation
+ minimal beginning separation
◯ distinct onset of separation
− complete separation

1. A liquid composition having a storage-stable monophasicness, comprising
(1) an isocyanate-reactive polyol component,
(2) at least one further isocyanate-reactive polyol component, this polyol component being inherently incompatible with the polyol component (1), and
(3) as compatibilizer additive at least one copolymer effectuating the monophasicness between the polyol components (1) and (2),
wherein the copolymer may comprise the following structural units I to VI and is constructed of at least one of the structural units I to III and of at least one of the structural units IV to VI: 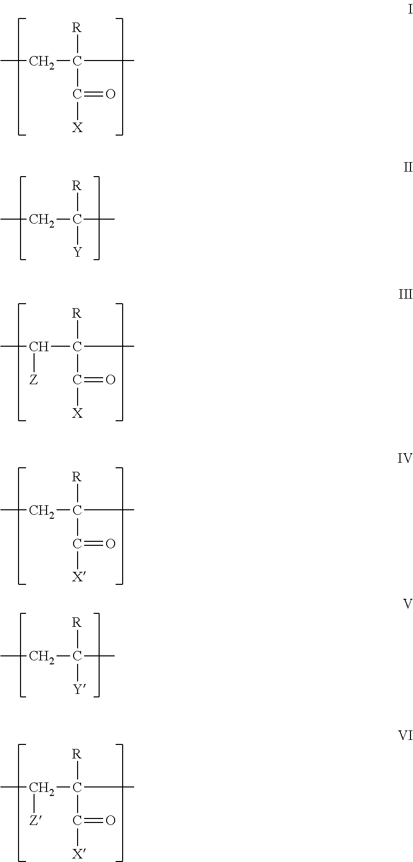
where
R represents hydrogen or an alkyl radical,
X represents an —OR₁ group or an 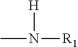
group, where
R₁ represents hydrogen, an alkyl radical, an alkenyl radical, an alkylene radical having a functional group, a cycloalkyl radical, an aromatic radical, wherein each of these radicals may optionally also be substituted, a polyether radical or polyester radical or a polyether/polyester radical;
Y represents an optionally substituted, aromatic non-basic radical of 4-12 carbon atoms which optionally has at least one heteroatom as ring member, a
lactam radical of 4-8 carbon atoms, a
polyether or polyester radical attached by an —O— or 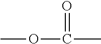
bridge, or an 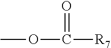
group, where
R₇ represents an optionally substituted alkyl radical or an optionally substituted cycloalkyl radical;
Z represents a —COOR₁ group, where R₁ is as defined above, or
Z combines with the 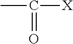
group where X is an —OR₁ group and R₁ represents hydrogen to form a cyclic anhydride group or where X is an 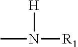
group to form a cyclic imide group whose nitrogen is substituted with an R₁ radical as defined above,
X′ represents an 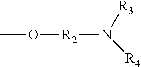
group or a corresponding, quaternized 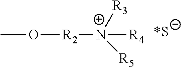
group, represents an 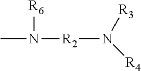
group or a corresponding, quaternized 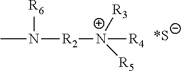
group, where R₂ represents an aliphatic radical, optionally an alkylene radical, or an aromatic radical, optionally arylene radical,
R₃, R₄ and R₅ are the same or different and each represent an alkyl radical, an aryl radical or arylalkylene radical, and the radicals R₃-R₅, which may optionally be substituted with a functional group, optionally a hydroxyl group, and R₆, the same or different, has the meaning of one of R₃-R₅ or represents hydrogen,
S⊖ represents the remaining, anionic radical of one of the hereinbelow recited alkylating compounds (4′), optionally a halide anion, bromide or iodide, or represents a sulfate anion or carboxylate anion, or
X′ represents a corresponding, salted 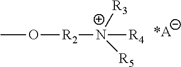
group
or a corresponding, salted 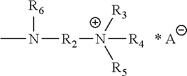
group, where R₂ is as defined above,
R₃, R₄, R₅ and R₆ are each as defined above, but at least one of R₃-R₅ represents hydrogen, and
A⊖ represents the remaining, anionic radical of one of the hereinbelow recited salting compounds (4), or
X′ as an 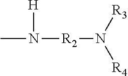
group combines with Z′ as a —COOR₁ group to form a cyclic imide group whose nitrogen is substituted with the 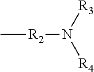
group with a corresponding, quaternized 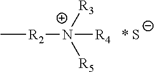
group or with a corresponding, salted 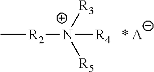
group,
where the radicals R₃, R₄, R₅, A⊖ and S⊖ are each as defined above,
Y′ represents an N-containing, heterocyclic, basic free radical, optionally an aromatic basic free radical containing at least one nitrogen atom and optionally further heteroatoms as ring members, or represents a saturated or unsaturated cycloaliphatic basic free radical containing at least one nitrogen atom and optionally further heteroatoms as ring members,
Z′, which is identical to or different from X′, represents a grouping having the meaning of X′ or represents a —COOR₁ group, where R₁ is as defined above,
where the structural units IV to VI are optionally at least partly present as salted with at least one optionally oligomeric organic compound (4) having at least one acidic group and/or optionally at least partly present as quaternized with an organic alkylating compound (4′).

2. A composition according to claim 1, wherein the polyol component (1) is at least one short-chain polyol, optionally an aliphatic polyol of 2-8 carbon atoms and at least two hydroxyl groups, or a polyalkylene oxide having at least two terminal hydroxyl groups, and the polyol component (2) is at least one polyether polyol and/or a polyester polyol.

3. A composition according to claim 1, wherein the polyol component (1) is ethylene glycol, butanediol, hexanediol or glycerol.

4. A composition according to characterized claim 1, wherein in the structural units I to VI
R represents hydrogen or a methyl or ethyl radical,
X represents an —NH—R₁ group or an —OR₁ group, where R₁ represents hydrogen, an alkyl radical of 1 to 6 carbon atoms, an alkylene radical having 1 to 6 carbon atoms and an OH group, optionally as end group, or represents a polyalkylene oxide radical,
Y represents an optionally substituted phenyl, naphthyl or pyrrolidine radical, an ε caprolactam radical, a polyalkylene oxide radical attached via an —O— bridge, or represents an acetate radical,
Z represents a —COOR₁ group, where R₁ is as defined above, or
Z combines with the 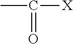
group where X is an —OR₁ group and R₁ represents hydrogen to form a cyclic anhydride grouping or where X is an 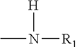
group to form a cyclic imide grouping whose nitrogen is substituted with an R₁ radical as defined above,
X′ represents an 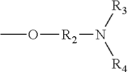
group or a corresponding, quaternized 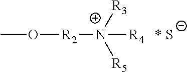
group, represents an 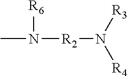
group or a
corresponding, quaternized 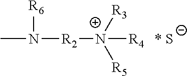
group, where R₂ represents an alkylene radical having 1 to 6 carbon atoms,
R₃, R₄, R₅ or R₆ are the same or different and each represent an alkyl radical of 1-3 carbon atoms or a benzyl radical, where the radicals R₃-R₅ may optionally each be substituted by an —OH group,
S⊖ represents the remaining, anionic radical of one of the hereinbelow recited alkylating compounds (4′), optionally a halide anion, chloride, bromide or iodide, or represents a sulfate anion or carboxylate anion,
or X′ represents a corresponding, salted 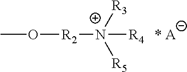
group
or a corresponding, salted 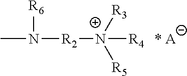
group, where R₂ is as defined above,
R₃, R₄, R₅ and R₆ are each as defined above, but at least one of R₃-R₅ represents hydrogen, and
A⊖ represents the remaining, anionic radical of one of the hereinbelow recited salting compounds (4),
or X′ as an 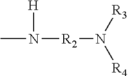
group combines with Z′ as a —COOR₁ group to form a cyclic imide group whose nitrogen is substituted with the 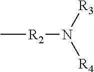
group or with a corresponding, quaternized or salted group,
Y′ represents a basic, aliphatic or aromatic, heterocyclic radical having 5-10 ring members and at least one nitrogen atom as ring member, and preferably represents an imidazole, pyrrole, pyrazole, pyrimidine, purine, quinoline or pyridine radical;
Z′, which is identical to or different from X′, represents a grouping having the above meaning of X′ or represents a —COOR₁ group, where R₁ is as defined above,
where the structural units IV to VI are optionally present as up to 75% salted with at least one oligomeric organic compound (4) having at least one acidic group and/or optionally present as quaternized with at least one organic alkylating compound (4′).

5. A composition according to claim 1, wherein the proportion of structural units IV-VI in the non-salted non-quaternized state is from 5% to 95% by weight, from based on the total weight of copolymer (3).

6. A composition according to claim 1, wherein the copolymer has a number-averaged molecular weight of 1000 to 250 000 g/mol.

7. A composition according to characterized wherein the copolymer has a random, gradientlike or blocklike construction of copolymerized structural units which optionally comprises comb structures.

8. A composition according to claim 7, wherein the copolymer is a diblock copolymer or triblock copolymer.

9. A composition according to claim 7 wherein the amount of structural units IV-VI in two adjacent blocks differs by at least 5% by weight.

10. A composition according to characterized claim 1, wherein the copolymer is produced by a controlled free-radical polymerization or an ionic polymerization.

11. A composition according to claim 10, wherein the copolymer is produced by a controlled free-radical polymerization nitroxyl.

12. A composition according to claim 10, wherein the copolymer is produced by group transfer polymerization.

13. A composition according to claim 1, wherein the structural units I-III of the copolymer are obtained by polymerization of ethylenically unsaturated monomers selected from the group consisting of (meth)acrylic esters, optionally having functional groups selected from the group consisting of OH, halogen, lactone and epoxy groups or derive from polyethers, (meth)acrylamides, optionally substituted styrene, maleic acid, maleic acid anhydride, maleic acid monoesters, maleic acid diesters, maleimides, vinyl-containing, non-basic heterocycles having at least one nitrogen atom as a ring member, and vinyl esters of carboxylic acids.

14. A composition according to claim 1, wherein the structural units IV-VI of the copolymer are obtained by polymerization of ethylenically unsaturated monomers selected from the group consisting of ethylenically unsaturated monomers having amino groups, and vinyl-containing basic, optionally aromatic heterocycles having at least one protonatable nitrogen atom as ring member, optionally (meth)acrylates and (meth)acrylamides having at least one amino group, C1-C6 alkyl(meth)acrylates having at least one amino group and (C1-C6)alkyl(meth)acrylamides having at least one amino group, and 4-vinylpyridine, 2-vinylpyridine and vinylimidazole, and oxirane-containing, ethylenically unsaturated monomers, optionally glycidyl methacrylate, which are reacted with reactive amines.

15. A composition according to characterized claim 1, wherein the copolymer is in liquid form.

16. A composition according to claim 1, wherein the copolymer is at least partially salted with at least one, optionally at least oligomeric, organic compound having carboxyl, sulfonic, phosphonic and/or phosphoric acid groups.

17. A composition according to claim 16, wherein the organic compound containing an acid group is a polyalkylene oxide, optionally formed from an ethylene and/or propylene oxide having 3-15 recurring units, having at least one carboxyl, sulfonic, phosphonic or phosphoric acid group, having at least one terminal carboxyl and/or phosphoric acid group.

18. A composition according to claim 17, wherein the polyalkylene oxide is additionally bonded to at least one fatty acid via an ester grouping and/or additionally to at least one C₁ to C₂₄ alcohol via an ether grouping.

19. A composition according to claim 1, wherein the copolymer is quaternized by reaction with at least one organic compound selected from the group consisting of optionally substituted alkyl halides, dialkyl sulfates and epoxy compounds combined with acids.

20. A composition according to claim 1, wherein the compatibilizer additive consists of a combination of an at least partially salted copolymer and of an at least partially quaternized copolymer.

21. A composition according to claim 1, wherein at least 5% by weight of the copolymer consists of salted and/or quaternized amino-containing structural units.

22. A composition according to that claim 1, wherein the composition further contains auxiliaries and addition agents.

23. A composition according to claim 22, wherein said auxiliary and addition agents are present at least one compound selected from the group consisting of catalysts, accelerants, chain crosslinkers, foaming agents, foam stabilizers, antifoams, deaerators, viscosity reducers, thioxotroping agents, heat stabilizers, flame retardants optionally together with oxidation inhibitors, dyes, pigments, organic or inorganic fillers, wetting and dispersing agents, process additives, adhesion promoters, release agents, plasticizers, antistats, oxidation stabilizers and solvents.

24. A composition according to that claim 2, wherein, based on 100% by weight formed from polyol component (1), polyol component (2) and copolymer (3), the proportion of component (1) is from 1% to 99% by weight, the proportion of component (2) is from 1% to 99% by weight and the proportion of copolymer (3) is from 0.1% to 10% by weight, subject to the proviso that the amount of components (1)-(3) must always add up to 100% by weight.

25. A composition according to claim 24, wherein, based on 100% by weight formed from polyol component (1), polyol component (2) and copolymer (3), the proportion of copolymer (3) is from 0.25% by weight to 5% by weight.

26. A for method for producing polyurethanes, wherein said polyurethanes are produced from a composition of claim 1.

27. A method according to claim 26, wherein the composition is reacted with at least one organic polyisocyanate component.

28. A method according to claim 26 and for producing a foamed or unfoamed polyurethane mass.

29. A process for producing a foamed or unfoamed polyurethane mass, wherein a composition according to claim 1 is reacted with at least one organic polyisocyanate compound in the presence of a catalyst.

30. A foamed or unfoamed polyurethane article obtained by reacting a composition according to claim 1 with at least one organic polyisocyanate component.
